(19) United States
(12) Patent Application Publication
(10) Pub. No.: US 2025/0298399 A1
(43) Pub. Date: Sep. 25, 2025

(54) APPARATUS, SYSTEMS, AND METHODS TO IDENTIFY PNEUMATIC LEAKS

(71) Applicant: Fisher Controls International LLC, Marshalltown, IA (US)

(72) Inventor: Philip Daniel Nelson, Union, IA (US)

(21) Appl. No.: 18/614,167

(22) Filed: Mar. 22, 2024

(51) Int. Cl. G05B 19/416

(52) U.S. Cl. CPC G05B 19/416; G05B 2219/37371

(57) ABSTRACT

Apparatus, systems, and methods to identify pneumatic leaks are disclosed herein. An example apparatus includes interface circuitry, machine-readable instructions, and at least one processor circuit to be programmed by the machine-readable instructions to generate an array including mean relay position values for a relay beam of a positioner associated with a control valve, the array including a first mean relay position value of the mean relay position values, perform a comparison of the first mean relay position value to a threshold rule, and cause an alert indicative of a leakage state of the positioner to be output for presentation at a user device based on the comparison.

### FIELD OF THE DISCLOSURE

This disclosure relates generally to control valves and, more particularly, to apparatus, systems, and methods to identify pneumatic leaks.

### BACKGROUND

A control valve typically includes a throttling element to regulate fluid flow through a pipe or other conduit. A pneumatic actuator can control a position of the throttling element using a fluid (e.g., air, gas) under pressure. A positioner (e.g., a servo controller) can control the fluid pressure supplied to the actuator.

### BRIEF DESCRIPTION OF THE DRAWINGS

FIG. 1 is a block diagram of an example system including an example control valve, an example actuator, an example positioner, and example leak detection circuitry to identify pneumatic leaks associated with the positioner.

FIG. 2 is a block diagram of an example implementation of the leakage detection circuitry of FIG. 1.

FIG. 3 illustrates an example heat map generated by the leakage detection circuitry of FIG. 2 for output at a user device.

FIG. 4 is a flowchart representative of example machine readable instructions and/or example operations that may be executed, instantiated, and/or performed by example programmable circuitry to implement the leakage detection circuitry of FIG. 2.

FIG. 5 is a block diagram of an example processing platform including programmable circuitry structured to execute, instantiate, and/or perform the example machine readable instructions and/or perform the example operations of FIG. 4 to implement the leakage detection circuitry of FIG. 2.

In general, the same reference numbers will be used throughout the drawing(s) and accompanying written description to refer to the same or like parts. The figures are not necessarily to scale.

### DETAILED DESCRIPTION

As noted above, a position of a throttling element of a control valve can be controlled by a pneumatic actuator to regulate fluid flow through the valve. In turn, the actuator is controlled by a positioner that controls fluid pressure supplied to the pneumatic actuator. However, leaks may occur with respect to the positioner and/or the actuator, which can affect operation of the control valve. For example, leaks may occur at inlet(s) or outlet(s) of the positioner, including the outlet(s) that output pressurized fluid to the actuator. Over time, a leak at the positioner can affect performance of the control valve and, in some instances, result in a reduced life cycle of the control valve.

Some known leak detection methods include operator-initiated tests that involve taking the control valve offline (e.g., shutting down the valve and/or associated components) for a period of time to perform testing at the positioner, the actuator, and/or the valve. However, such operator-initiated tests to identify leakage events can be inefficient because of disruption to operation of the control valve, resources consumed, etc. Further, in systems that include multiple control valves, it may be difficult for an operator to identify leaks among the plurality of control valves, to routinely perform leakage detection tests for each of the valves, etc. Some known leakage detection tests are at least partially automated in that the tests identify potential leaks based on sensor data. For example, some known leakage detection tests estimate a leakage event at a positioner based on data from multiple sensors (e.g., pressure sensors at various locations within the positioner). However, such tests typically rely on several variables to identify a leak, which can affect reliability of the resulting leakage detection analysis. Further, such sensor-based tests are typically user-initiated and, thus, may still rely on an operator to suspect a leak before the analysis is performed.

Disclosed herein are example apparatus, systems, and methods that provide for dynamic detection of leaks associated with a control valve and, in particular, leaks associated with a positioner for the control valve. Examples disclosed herein can detect, for example, leakage events associated with outlet(s) of the positioner fluidly coupled to a pneumatic actuator that controls the position of the valve. Examples disclosed herein use relay position data representing positions of a relay beam of the positioner over time and generated based on outputs of sensor(s) of the positioner to identify leak-to-atmosphere instances at the positioner. In particular, the relay beam rotates or pivots to control output pressure to the actuator. Increases in relay position values over time in a direction of rotation associated with increased output pressure can indicate that the relay beam position is changing to compensate for additional fluid flow due to a leak at the positioner. For instance, in response to a leak-to-atmosphere event at the positioner, the relay beam can move to increase output pressure to enable the positioner to maintain the same output fluid pressure for the actuator that would be achieved without the leak. Thus, examples disclosed herein use the relay position data as a proxy for identifying leaks occurring from the supply pressure received at the positioner to the output pressure, leaks at the outlet of the positioner and the actuator that receives fluid pressure (e.g., air pressure) from the positioner, etc. In examples disclosed herein, a time series analysis of the relay position data is performed to identify leakage states of the positioner.

Examples disclosed herein provide for reliable detection of leakage events at the positioner based on relay position data. In examples disclosed herein, a rolling mean of the relay position data is calculated over a period of time and an array of mean relay position values is generated to determine leakage states of the positioner. Thus, examples disclosed herein consider behavior of the positioner over time when identifying leakage states, therefore reducing effects of anomalies that could impact the result of the analysis (e.g., reduce false negatives). Further, the use of one variable, namely, the relay position data, to identify leakage states of the positioner increases efficiency and consistency in detecting leaks. Prior to performing the analysis, some examples disclosed herein remove relay position data points associated with the valve being in a fully open or fully closed position as represented by travel feedback data that represent the position of the actuator. In particular, values associated with the relay beam position in the fully open or fully closed positions may inadvertently imply increased changes in relay position to compensate for a leak. Thus, examples disclosed herein use relay position data associated with modulation of the control valve for leakage detection. Therefore, the filtered relay position data reflects behavior by the relay in connection with operation of the actuator to control the position of the valve between various intermediate positions, removes relay position data that may be outlying data when the valve is in the fully closed or fully open position, etc.

Examples disclosed herein provide for tiered identification of leakage states (e.g., no or likely no leakage event, a potential leakage event that warrants monitoring, an actual or likely leakage event that warrants action) of the positioner. In particular, examples disclosed herein compare the relay position data to threshold values associated with the various possible leakage states of the positioner to determine the leakage state of the positioner. Examples disclosed herein analyze changes in the relay position data over time to identify changes in leakage states. For example, changes in the rolling mean values of the relay beam position can be used to predict or identify that a leakage state of the positioner is likely to change from or has changed from, for example, a potential leakage event to an actual leakage event. Examples disclosed herein automatically generate and output different levels of alerts (e.g., critical, warning) based on the detected leakage state.

Examples disclosed herein perform leakage detection analysis and monitoring without user involvement. In particular, examples disclosed herein automatically monitor relay position data over time and generate alerts based on the determined leakage state of the positioner. Examples disclosed herein enable improved leakage detection in environments containing, for instance, multiple control valves. In particular, examples disclosed herein generate a heat map to provide a visual indicator (e.g., visual representation) of which valves in the environment may need attention. Examples disclosed herein can continuously monitor the leakage states based on the relay position data and update the heat map when the leakage state of a positioner changes.

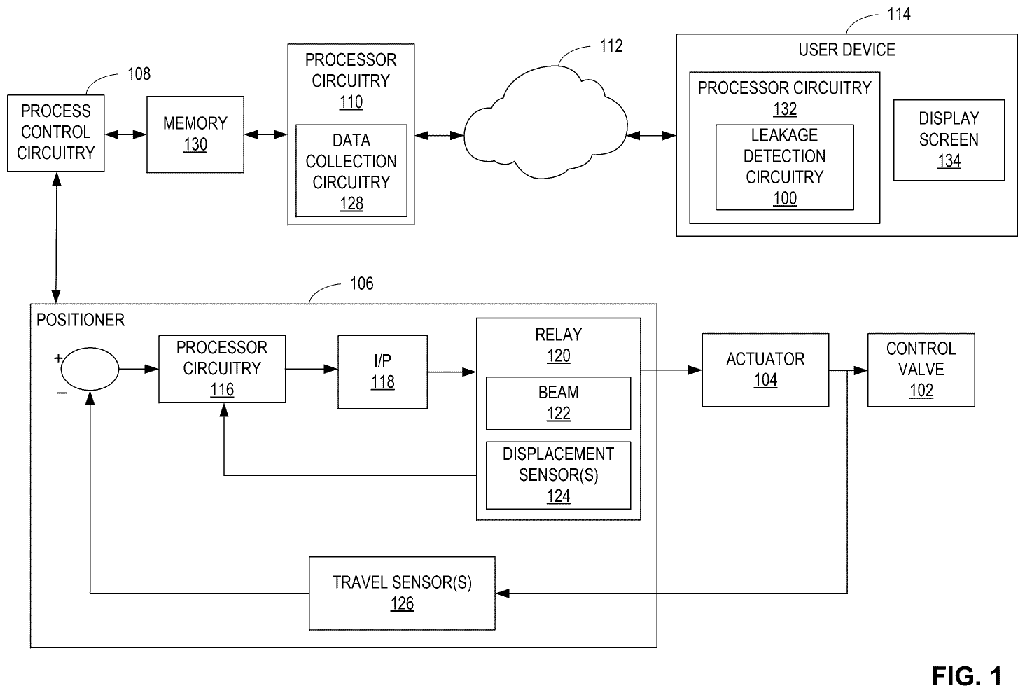

FIG. 1 is a block diagram of an example system in which example leakage detection circuitry 100 operates to identify pneumatic leaks associated with a positioner 106 for a control valve 102. Although one control valve 102 is shown in FIG. 1 for illustrative purposes, the example system of FIG. 1 can include additional control valves, where each control valve is associated with a respective positioner. The control valve 102 controls the flow of a fluid through a pipe (e.g., conduit, tube, etc.) (not shown in FIG. 1). An actuator 104 is operatively coupled to the control valve 102 to control a position of a stem of the control valve 102 and, thus, to regulate flow through the control valve 102. In the example of FIG. 1, the actuator 104 is a pneumatic actuator. The positioner 106 is operatively coupled to the actuator 104 to control fluid pressure (e.g., air pressure) supplied to the actuator 104. The fluid pressure from the positioner 106 acts on a diaphragm or piston of the actuator 104, resulting in adjustments to the position of the control valve stem. For example, the control valve 102 can move between a fully closed position (i.e., no fluid flow therethrough), a fully open position, and intermediate modulated positions between the fully closed position and fully open position.

The example positioner 106 of FIG. 1 includes processor circuitry 116, a current-to-pressure I/P converter 118, a relay 120, displacement sensor(s) 124, and travel sensor(s) 126. In the example of FIG. 1, the positioner 106 is in communication with process control circuitry 108 (e.g., integrated circuits, logic circuits, FPGAs, microprocessors, CPUs, GPUs, DSPs, and/or microcontrollers). The process control circuitry 108 generates instructions or commands to control operation of the control valve 102 via the positioner 106 and the actuator 104. For example, the process control circuitry 108 outputs a reference signal (e.g., a command signal) to the positioner 106, where the reference signal includes travel setpoint(s) that represent particular (e.g., desired, target) position(s) of the actuator 104. The (e.g., desired, target) travel setpoint(s) can be stored in a memory 130 (e.g., a database, a data store) accessible to the process control circuitry 108. In examples in which the system of FIG. 1 includes other control valves 102, the process control circuitry 108 is communicatively coupled to the respective positioners 106 to control operation of the other control valves 102.

In the example of FIG. 1, the positioner 106 compares the reference signal received from the processor control circuitry 108 to a position (e.g., a current position, an actuator position) of the actuator 104. The position (e.g., current position) of the actuator 104 can be identified based on outputs of the travel sensor(s) 126. In FIG. 1, the travel sensor(s) 126 generate outputs representing the position (e.g., current position) of the actuator 104 and provides the outputs to the processor circuitry 116, which generates travel feedback data indicative of current or actual position(s) of the actuator at particular time(s) based on the sensor outputs. The processor circuitry 116 of the positioner 106 generates an electronic I/P drive signal to control the I/P converter 118 based on the comparison between the reference signal and the actuator position.

The I/P converter 118 is operatively coupled to the relay 120 and controls the operation of the relay 120 based on the electronic I/P drive signal from the processor circuitry 116. The relay 120 is fluidly coupled to the actuator 104 and a source of pressurized supply fluid. The relay 120 controls the flow of control fluid supplied to the actuator 104 via rotation of a relay beam 122 based on input from the I/P converter 118. The pneumatic actuator 104 of FIG. 1 includes a diaphragm or a piston that divides a housing of the pneumatic actuator 104 into two chambers. The position of the relay beam 122 determines the flow of control fluid supplied to each chamber of the actuator 104. The displacement sensor(s) 124 generate outputs representing the position of the relay beam 122 at a given time. The outputs of the displacement sensor(s) 124 are provided to the processor circuitry 116, which generates relay position data representing the position (e.g., angular position) of the relay beam 122 over time based on the sensor outputs. For example, the relay position data includes relay position data points corresponding to the position of the relay beam 122 at different times based on the outputs of the displacement sensor(s) 124.

In the example of FIG. 1, the relay position data and the travel feedback data generated based on the outputs of the respective sensors 124, 126 is shared between the processor circuitry 116 of the positioner 106 and the process control circuitry 108. For example, the relay position data and the travel feedback data can be stored in the memory 130 (e.g., a database, a data store) accessible by the processor circuitry 116 and the process control circuitry 108 (e.g., a memory implemented at the positioner 106, by a cloud device, etc.). In some examples, the process control circuitry 108 collects (e.g., retrieves, obtains) the relay position data and/or the travel feedback data on a polling schedule (e.g., once a day, twice a day, etc.) and stores the relay position data and/or the travel feedback data in the memory 130. In some examples, relay position data and/or the travel feedback data may be collected by or otherwise provided to the process control circuitry 108 as a result of user input. In some examples, the processor circuitry 116 of the positioner 106 periodically causes the relay position data and/or the travel feedback data to be transmitted to the memory 130 for access by the process control circuitry 108. For example, the positioner 106 can transmit the relay position data and/or the travel feedback data when new data is generated, at user-defined intervals such as once a day, every hour, etc.

In the example of FIG. 1, data collection circuitry 128 facilitates access of the relay position data between the memory 130 and the leakage detection circuitry 100 via a cloud 112. The data collection circuitry 128 can be implemented by processor circuitry 110 associated with the process control circuitry 108, one or more user devices, one or more cloud-based devices (e.g., one or more server(s), processor(s), and/or virtual machine(s)), etc.

The leakage detection circuitry 100 of FIG. 1 identifies pneumatic leaks based on time series analysis of the relay position data and generates outputs to be presented via a user device 114, such as via a display screen 134 of the user device 114. In the example of FIG. 1, the leakage detection circuitry 100 is implemented by processor circuitry 132 of a user device 114 (e.g., a compute device such as a personal compute device (e.g., a desktop, a laptop), a mobile device (e.g., an electronic tablet, a smartphone), etc. However, the leakage detection circuitry 100 can be implemented by the cloud 112, by the cloud 112 and the user device 114 (e.g., one or more elements of the leakage detection circuitry 100 are implemented at the cloud 112 and one or more other elements are implemented at the user device 114), by processor circuitry of other devices, etc.

The leakage detection circuitry 100 of FIG. 1 receives, accesses, otherwise obtains as input the relay position data including the relay position data points corresponding to the position of the relay beam 122 at different times. The leakage detection circuitry 100 also receives, accesses, or otherwise obtains the travel feedback data from the process control circuitry 108 representing particular position(s) of the actuator 104. Based on these inputs (i.e., the relay position data points, the travel feedback data), the example leakage detection circuitry 100 determines whether, for instance, there is a leak from the supply pressure to the output pressure, whether there is a positioner output leak to atmosphere, etc. In some examples, the leakage detection circuitry 100 receives as input the relay position data points and not the travel feedback data. In such examples, the leakage detection circuitry 100 may access the target or desired travel setpoint data or identify leakage events based on the relay position data without filtering based on the travel setpoint(s). Although in the example of FIG. 1, the leakage detection circuitry 100 obtains the relay position data points and the travel feedback data stored in the memory 130 via the data collection circuitry 128 and the cloud 112, other communicative pathways can be used to transmit the data. For example, in some examples, the leakage detection circuitry 100 can directly access the memory 130 and/or (e.g., directly) receives data from the sensor(s) 124, 126).

In some examples, the leakage detection circuitry 100 uses the travel feedback data to filter the relay position data points to remove the relay beam positions associated with the control valve 102 being a fully closed or fully open position to generate a dataset representing relay beam position during modulation of the control valve 102. The example leakage detection circuitry 100 calculates a mean of the relay position values based on a threshold number of the (e.g., filtered) relay position data points collected over time. As additional relay position data points are generated (e.g., based on additional outputs of the displacement sensor(s) 124 representing positions of the relay beam 122 over time), the example leakage detection circuitry 100 calculates an updated mean based on the additional relay position data points. Thus, the example leakage detection circuitry 100 generates an array of rolling mean values associated with relay beam position.

The example leakage detection circuitry 100 analyzes the rolling mean values of relay beam position to determine a leakage state (e.g., no leak indicated, leak likely developing, active leakage event) of the positioner 106. In some examples, the leakage detection circuitry 100 compares the most recently calculated mean in the array to threshold values to determine the leakage state of the positioner 106. In some examples, the leakage detection circuitry 100 analyzes changes in the calculated mean values over time to predict that threshold values indicative of leakage events at the positioner 106 are likely to be satisfied (e.g., within a threshold period of time).

The example leakage detection circuitry 100 of FIG. 1 provides for visual indicator(s) with respect to a status of the positioner 106 and/or the associated control valve 102 (and any other positioners and/or control valves in the example system of FIG. 1) in view of the positioner leakage state analysis. The visual indicator(s) can be presented via the display screen 134 of the user device 114. In some examples, the leakage detection circuitry 100 generates a heat map including visual indicators representing the leakage states for a plurality of the positioners 106. In some examples, the heat map includes different visual indicators (e.g., colors) representing different levels or states of leakage detection for the positioners 106 (e.g., red for a positioner identified as experiencing a leakage event, yellow for a positioner that is likely to develop a leak, green for a positioner with no indication of leakage). The example leakage detection circuitry 100 dynamically updates the heat map to reflect any changes in the leakage detection analysis over time. For example, the leakage detection circuitry 100 causes a visual indicator for a positioner that was previously identified as not experiencing a leakage event to change from green to yellow (or red) if the analysis performed by the leakage detection circuitry 100 indicates that a leakage event is expected (or is occurring or likely occurring).

Additionally or alternatively, when a leakage event or a potential leakage event is detected, the leakage detection circuitry 100 can cause other types of alert(s) to be output via the user device 114 (e.g., in addition to or as an alternative to the heat map). The alert(s) can include, but are not limited to, visual alerts (e.g., a light, a warning message on the display screen 134 of the user device 114), audio alerts (e.g., a sound), a combination thereof and/or any other alert(s).

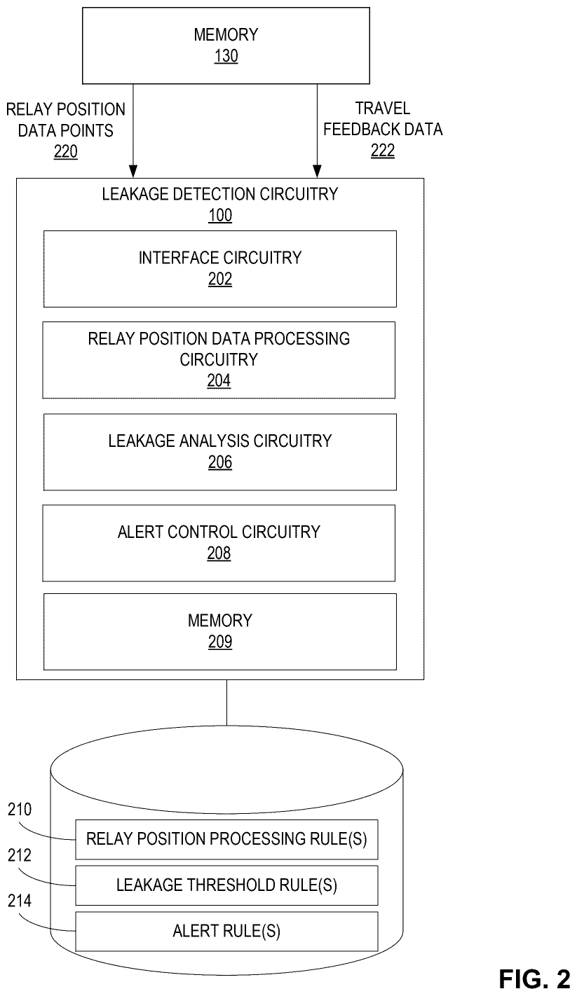

FIG. 2 is a block diagram of an example implementation of the leakage detection circuitry 100 of FIG. 1 to identify pneumatic leaks based on relay position time series analysis and provide outputs indicative of leakage events. The leakage detection circuitry 100 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the leakage detection circuitry 100 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example leakage detection circuitry 100 of FIG. 2 includes example interface circuitry 202, example relay position data processing circuitry 204, example leakage analysis circuitry 206, and example alert control circuitry 208.

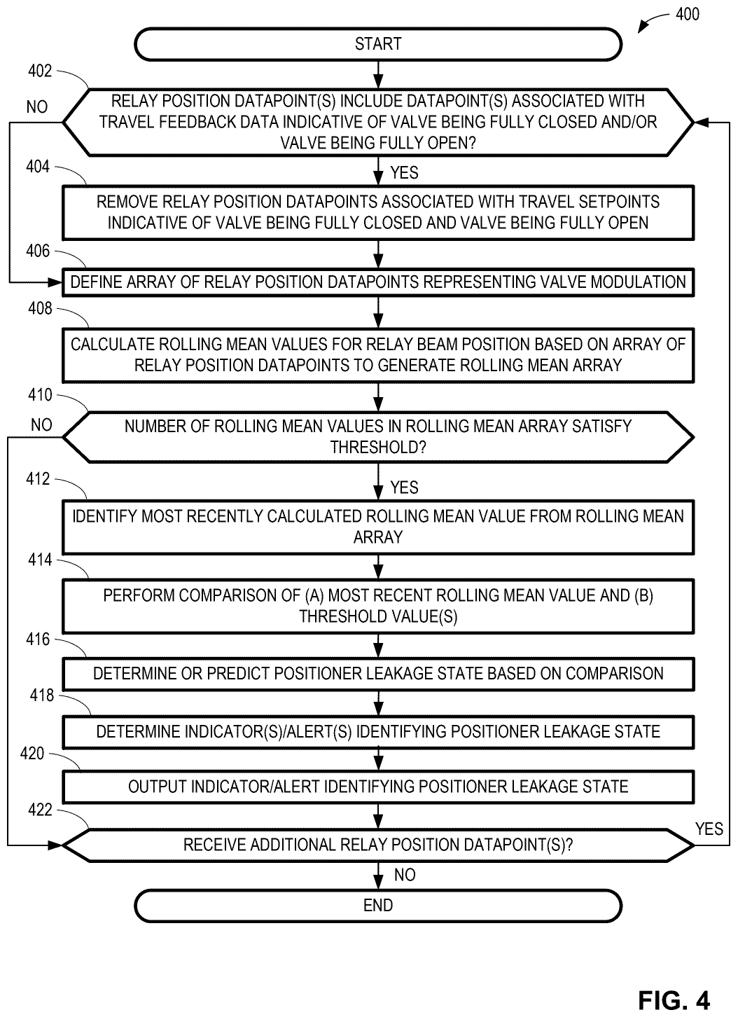

In the illustrated example, the interface circuitry 202 of the example leakage detection circuitry 100 is communicatively coupled to the memory 130 (e.g., via the cloud 112) to access or receive relay position data points 220 representing positions (e.g., angular positions) of the relay beam 122 of the positioner 106 of FIG. 1 at particular times. Also, the interface circuitry 202 accesses or receives travel feedback data 222 representing positions of the actuator 104 at particular times and, thus, indicative of control valve positions, from the memory 130. In other examples, the interface circuitry 202 can communicate (e.g., directly communicate) with one or more the processor circuitry 116, the displacement sensor(s) 124, and/or the travel sensor(s) 126 to access the relay position data points 220 and/or the travel feedback data 222. In some examples, the relay position data points 220 and/or the travel feedback data 222 include the time each data point was obtained (i.e., time-stamped data). The example interface circuitry 202 stores the relay position data points 220 and the travel feedback data 222 in a memory 209 (e.g., a data store, a database) for access by the relay position data processing circuitry 204 for processing (e.g., filtering). The interface circuitry 202 may be implemented by any type of interface standard, such as an Ethernet interface, a universal serial bus (USB), a Bluetooth® interface, a near field communication (NFC) interface, and/or a PCI express interface. In some examples, the interface circuitry 202 is instantiated by programmable circuitry executing interface instructions and/or configured to perform operations such as those represented by the flowchart of FIG. 4.

The example relay position data processing circuitry 204 of the leakage detection circuitry 100 of FIG. 2 accesses the relay position data points 220 and the travel feedback data 222 stored in the memory 209 via the interface circuitry 202. The example relay position data processing circuitry 204 processes the relay position data points 220 according to relay position processing rule(s) 210. The relay position processing rule(s) 210 can be defined by user input(s) and stored in the memory 209 accessible to the relay position data processing circuitry 204. In some examples, the relay position data processing circuitry 204 filters the relay position data points 220 to remove data points associated with the travel feedback data 222 that indicate the control valve 102 was in a fully open position or fully closed position (e.g., where the association between the relay position data points 220 and the actuator travel feedback data 222 can be determined based on the time-stamps). In the example of FIG. 2, the relay position processing rule(s) 210 define that the relay position data points 220 associated with the fully open or fully closed positions should be removed because the position of the relay beam 122 when the valve is in a fully open or fully closed position may change a greater amount than when the valve 102 is modulated between intermediate positions. Thus, the relay beam position when the valve 102 is in the fully open or fully closed positions could skew the leakage detection analysis by falsely implying an increased change in relay position in a direction associated with increased output pressure to compensate for a leak. In other examples, the relay position data processing circuitry 204 may identify and remove/replace outlier relay position data points 220 without using the travel feedback data 222 (e.g., using target or reference travel setpoint(s), signal processing filters, linear interpolation).

The example relay position data processing circuitry 204 generates a relay position array based on the relay position data points 220 associated with valve modulation remaining after the filtering. The example relay position data processing circuitry 204 calculates rolling mean values representing average relay beam position over time using the relay position data points 220 in the relay position array. The time series for which the relay position data processing circuitry 204 calculates each rolling mean value can be defined by a particular number, subset, or window of the relay position data points 220 in the relay position array. For example, the relay position processing rule(s) 210 can define that the rolling mean values of relay beam position should be calculated for rolling time intervals or windows represented by, for example, 30 relay position data points 220 in the relay position array. In some examples, the relay position data processing circuitry 204 does not calculate the rolling mean until the relay position array includes a threshold number of relay position data points 220 (e.g., a minimum of 30 data points) as defined by the relay position processing rule(s) 210. For instance, the example relay position data processing circuitry 204 calculates a first rolling mean of the relay position data points 220 in the relay position array once the threshold number of relay position data points 220 is in the array (e.g., a minimum of 30 data points in the array). The relay position data processing circuitry 204 calculates another rolling mean in response to another relay position data point 220 that is added to the relay position array (e.g., using a data subset including the newly added relay position data point and the last 29 relay position data points in the array before the newly added data point). As additional relay position data point(s) 220 are added to the relay position array over time, the example relay position data processing circuitry 204 continues to calculate rolling mean values for the relay beam position based on subsets defined by the last n relay position data points 220 in the array (e.g., where n is the rolling window of the relay position data points 220 defined by the relay position processing rule(s) 210 for determining the rolling mean, e.g., n=30).

As an example, assuming that one relay position data point 220 is added to the relay position array each day and that data point is not filtered or removed from the analysis, the relay position data processing circuitry 204 can calculate the first rolling mean based on the relay position data points 220 collected for days 1-30. The relay position data processing circuitry 204 can calculate a second rolling mean based on the relay position data points 220 collected for days 2-31 in response to a relay position data point 220 associated with day 31 being added to the array. The relay position data processing circuitry 204 generates a rolling mean array including the rolling means calculated from the (e.g., filtered) relay position data points 220 of the relay position array. The relay position array and/or the rolling mean array can be stored in the memory 209.

The relay position data processing circuitry 204 can perform various filtering and/or processing operations on the relay position data points 220 to generate trimmed data set(s) based on the relay position processing rule(s) 210. As disclosed above, the relay position data processing circuitry 204 calculates the respective rolling means based on a pre-determined interval of data point entries (e.g., the most recent 5 relay position data points 220 in the array, the most recent 10 relay position data points 220, the most recent 30 relay position data points 220). In some examples, the relay position data processing circuitry 204 excludes a portion of the highest values (e.g., top 5%, top 10%) and a portion of the lowest values (e.g., bottom 5%, bottom 10%) in the relay position array before calculating the mean (e.g., to exclude potential anomalies). Thus, the rolling mean array including the rolling mean values of relay beam position can be considered an array of trimmed mean values. In some examples, the relay position data processing circuitry 204 is instantiated by programmable circuitry executing relay position data processing instructions and/or configured to perform operations such as those represented by the flowchart of FIG. 4.

The example leakage analysis circuitry 206 of the leakage detection circuitry 100 of FIG. 2 analyzes the rolling mean array to determine the leakage state of the positioner 106. In some examples, the relay position data processing circuitry 204 provides the rolling mean array for analysis by the leakage analysis circuitry 206 (and/or the leakage analysis circuitry 206 accesses the rolling mean array for analysis) when the rolling mean array includes a threshold number of rolling mean values (e.g., at least 10 rolling mean values). The threshold number of rolling mean values can be defined by the relay position processing rule(s) 210. In examples in which the rolling mean array does not include the threshold number of rolling mean values, the relay position data processing circuitry 204 continues to calculate the rolling mean values based on additional relay position data points 220 collected over time until the threshold is satisfied. The threshold number of rolling mean values can be selected based on a minimum time frame for which the relay beam position is to be monitored to capture development and progression of potential leak events, to account for anomalies in the data, etc.

In the example of FIG. 2, the leakage analysis circuitry 206 identifies the most recent rolling mean value calculated by the relay position data processing circuitry 204 (i.e., the most recently calculated rolling mean in the rolling mean array). The leakage analysis circuitry 206 determines the leakage state (e.g., no leak indicated, leak likely developing, active leakage event) of the positioner 106 by comparing the most recent rolling mean value to threshold value(s) defined by leakage threshold rule(s) 212. The leakage threshold rule(s) 212 can be defined by user input(s) and stored in the memory 209. The leakage threshold rule(s) 212 can define threshold relay beam position value(s) that are indicative of leakage states or tiers such as (a) no or likely no leakage event, (b) a potential or developing leakage event, or (c) an actual or likely leakage event.

For example, the leakage analysis circuitry 206 can determine that the most recent rolling mean value calculated by the relay position data processing circuitry 204 satisfies a first threshold rule in that the most recent rolling mean value falls below a first threshold value, indicating a likely leak at the positioner 106 from the supply pressure received at the positioner 106 (e.g., received by the relay 120) to the output pressure generated by the positioner 106 for the actuator 104. In such examples, the leakage analysis circuitry 206 identifies the positioner leakage state as an actual or likely leakage event that warrants action.

In some examples, the leakage analysis circuitry 206 can determine that the most recent rolling mean value calculated by the relay position data processing circuitry 204 satisfies a first threshold rule but not a second threshold rule. For examples, the leakage analysis circuitry 206 can determine that the most recent rolling mean value falls between the first threshold value and a second threshold value, indicating a possible drift of the relay beam 122 and/or leak from the supply pressure received at the positioner 106 to the output pressure generated by the positioner 106 for the actuator 104. In such examples, the leakage analysis circuitry 206 identifies the positioner leakage state as a potential leakage event that warrants monitoring.

In some examples, the leakage analysis circuitry 206 can determine that the most recent rolling mean value calculated by the relay position data processing circuitry 204 falls between the second threshold value and a third threshold value, indicating the relay position is within an expected range and, thus, the positioner 106 is not showing or not expected to show signs of degradation, pressure compensation, etc. In such examples, the leakage analysis circuitry 206 identifies the positioner leakage state as no or likely no leakage event.

In some examples, the leakage analysis circuitry 206 can determine that the most recent rolling mean value calculated by the relay position data processing circuitry 204 falls between the third threshold value and a fourth threshold value, indicating a possible leak of the positioner output. In such examples, the leakage analysis circuitry 206 identifies the positioner leakage state as a potential leakage event that warrants monitoring.

In some examples, the leakage analysis circuitry 206 can determine that the most recent rolling mean value calculated by the relay position data processing circuitry 204 is above the fourth threshold value, indicating a likely leak to atmosphere at the positioner 106 (e.g., at an outlet of the positioner 106). In such examples, the leakage analysis circuitry 206 identifies the positioner leakage state as an actual or likely leakage event that warrants action. Thus, the example leakage analysis circuitry 206 compares the most recent rolling mean value to various threshold values to determine whether or not one or more leakage threshold rule(s) are satisfied.

In some examples, the leakage analysis circuitry 206 analyzes the rolling mean values selected from the rolling mean array over time to identify changes in relay beam position behavior. In some examples, based on the analysis over time, the leakage analysis circuitry 206 can predict that future rolling mean values are likely to satisfy the threshold values that indicate that a leak is likely developing in the positioner 106 or has developed. For example, based on comparison to the leakage threshold rule(s) 212, the leakage analysis circuitry 206 can determine that a first rolling mean value selected at a first time falls below the threshold value (e.g., the fourth threshold value mentioned above) indicating that a leakage event is likely. The leakage analysis circuitry 206 can determine that a second rolling mean value selected at a second time falls below the threshold value indicating that a leakage event is likely, but the second rolling mean value is closer to meeting the threshold value for a leakage event than the first rolling mean value. Thus, the leakage analysis circuitry can predict that later selected rolling mean value(s) will indicate that the leakage event is likely because the rolling mean values are trending toward (e.g., likely to satisfy or surpass) the threshold value associated with a leakage event. Based on the trend of the rolling mean values relative to the leakage threshold rule(s) 212, the leakage analysis circuitry 206 may predict a future failure of control due to a leak to atmosphere at the positioner 106 (e.g., because the trend of the rolling mean values indicates that the values are likely to satisfy the threshold value indicative of a leakage event). In some examples, the leakage analysis circuitry 206 is instantiated by programmable circuitry executing leakage analysis instructions and/or configured to perform operations such as those represented by the flowchart of FIG. 4.

The alert control circuitry 208 of the example leakage detection circuitry 100 generates alert(s) and/or indicator(s) based on the leakage state(s) determined by the leakage analysis circuitry 206 and according to alert rule(s) 214. The alert rule(s) 214 can be defined by user input(s) and stored in the memory 209. The alert rule(s) 214 define the type of alert(s) and/or indicator(s) (e.g., visual, audio, etc.) to be generated, the characteristics (e.g., color, noise level, etc.) of the alert(s) and/or indicator(s) to be generated, the frequency with which alert(s) and/or indicator(s) are generated, etc.

For example, alert control circuitry 208 can generate an alert, such as a visual alert such as a flashing icon and/or an audio alert, to be output to the user via, for example, the user device 114 of FIG. 1 to indicate that a leak is occurring at the positioner 106. In some examples, the alert control circuitry 208 generates an indicator for a positioner 106, regardless of the determined leakage state (e.g., to show that the positioner 106 is likely experiencing a leak or to show the positioner 106 is not likely experiencing a leak). In other examples, the alert control circuitry 208 only generates alerts for positioner(s) 106 that the leakage analysis circuitry 206 determines are experiencing or likely experiencing a leakage event. In some examples, the alert control circuitry 208 generates an alert to indicate that the positioner 106 is likely experiencing relay beam drift. In some examples, the alert control circuitry 208 generates alerts for predicted or expected leakage states at positioner(s) 106 in addition to determined leakage states.

In some examples, the alert control circuitry 208 generates a heat map with indicators or alerts corresponding to leakage states for a plurality of positioners 106. In some examples, the heat map includes different visual indicators (e.g., colors) representing different levels or states of leakage detection for the positioners 106 based on the comparison of the rolling mean value(s) to the leakage threshold rule(s) 212. In some examples, the heat map includes different visual indicators to distinguish between determined leakage states for the positioners 106 and predicted future leakage states for the positioners 106. The example leakage detection circuitry 100 dynamically updates or adjusts the heat map to reflect any changes in the leakage detection analysis over time for a particular positioner 106. For example, the leakage detection circuitry 100 can cause a visual indicator for a positioner 106 that was previously identified as not experiencing a leakage event to change from green (e.g., representing no leakage event) to yellow (e.g., representing relay beam drift or possible leak) or red (e.g., representing an actual or likely leakage event) if the analysis indicates that a leakage event is expected (yellow alert) or is occurring or likely occurring (red alert). In some examples, the alert control circuitry 208 is instantiated by programmable circuitry executing alert control instructions and/or configured to perform operations such as those represented by the flowchart of FIG. 4.

While an example manner of implementing the leakage detection circuitry 100 of FIG. 1 is illustrated in FIG. 2, one or more of the elements, processes, and/or devices illustrated in FIG. 2 may be combined, divided, re-arranged, omitted, eliminated, and/or implemented in any other way. Further, the example interface circuitry 202, the example relay position data processing circuitry 204, the example leakage analysis circuitry 206, the example alert control circuitry 208, the example memory 209, and/or, more generally, the example leakage detection circuitry 100 of FIG. 2, may be implemented by hardware alone or by hardware in combination with software and/or firmware. Thus, for example, any of the example interface circuitry 202, the example relay position data processing circuitry 204, the example leakage analysis circuitry 206, the example alert control circuitry 208, the example memory 209, and/or, more generally, the example leakage detection circuitry 100, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example leakage detection circuitry 100 of FIG. 2 may include one or more elements, processes, and/or devices in addition to, or instead of, those illustrated in FIG. 2, and/or may include more than one of any or all of the illustrated elements, processes and devices.

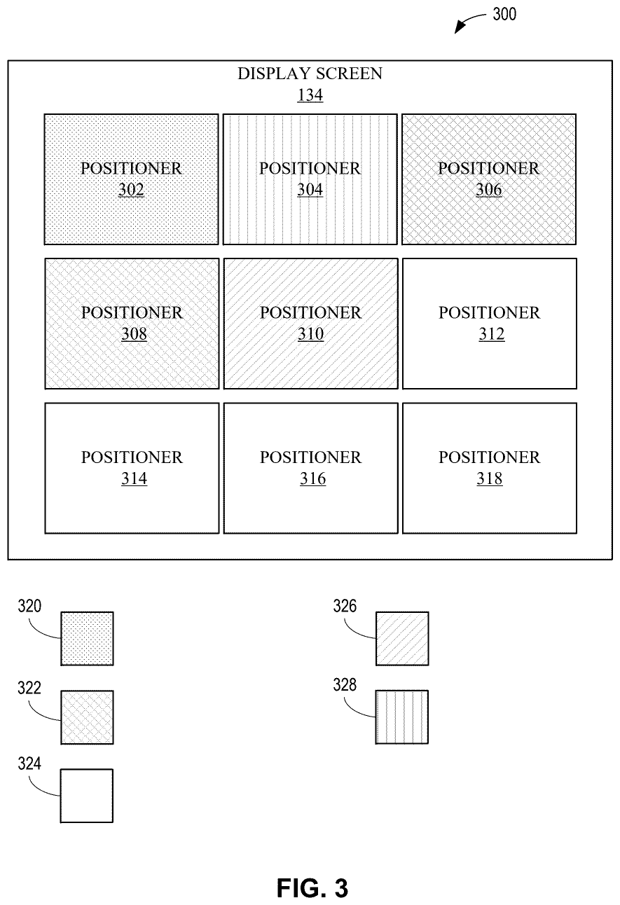

FIG. 3 illustrates an example heat map 300 that may be generated by the alert control circuitry 208 of the example leakage detection circuitry 100 of FIG. 2. The example heat map 300 may be displayed on, for example, the display screen 134 of the user device 114 of FIG. 1. The example heat map 300 includes visual indicators 320, 322, 324, 326, 328 representing determined leakage states for example positioners 302, 304, 306, 308, 310, 312, 314, 316, 318 at a particular time. In the illustrated example, the visual indicator 320 represents an actual or likely leak from the supply pressure to the output pressure of a positioner (e.g., the example positioner 302) that warrants action. The example visual indicator 322 represents possible relay beam drift and/or a possible or developing leak from the supply pressure to the output pressure of a positioner (e.g., the example positioners 306 and 308) that should be monitored. The example visual indicator 324 represents likely no leakage event at a positioner (e.g., the example positioners 312-318). The example visual indicator 326 represents a possible leak of the positioner output (e.g., at an outlet of the example positioner 310) that should be monitored. The example visual indicator 328 represents an actual or likely leak of the positioner output to atmosphere at a positioner (e.g., at an outlet of the example positioner 304) that warrants action. The example heat map 300 may be updated by leakage detection circuitry 100 to reflect changes in the determined leakage states of the respective positioners 302-318 over time.

In the illustrated example, the heat map 300 is arranged by leakage state and corresponding priority. For instance, example positioners 302 and 304 identified as experiencing a leakage event are listed first, followed by positioners 306-310 identified as likely to develop a leak, followed by positioners 312-318 with no indication of leakage. In other examples, the heat map is organized based on the physical location of the positioners 302-318 in the environment. In some examples, a user of the user device 114 can filter the heat map 300 and/or determine the arrangement of the heat map 300.

In the illustrated example, the heat map 300 includes five visual indicators 320-328 to represent different leakage states of the positioners 302-318. In other examples, the heat map 300 may include fewer (e.g., 2, 3) or more visual indicators representing different leakage states of the positioners 302-318. The example heat map 300 includes visual indicators 320-328 illustrated as different patterns. The heat map 300 may include visual indicators that vary by any characteristic (e.g., color, size, shape, etc.) or combination of characteristics to differentiate between leakage states. For example, the heat map 300 may display colors such as green (e.g., representing no leakage event), yellow (e.g., representing relay beam drift or possible leak), and red (e.g., representing an actual or likely leakage event) visual indicators. In some examples, the heat map 300 includes different visual indicators to indicate the leakage event is a predicted leakage event, rather than an identified leakage event. For example, the heat map 300 can indicate an actual or likely identified leakage event with a red square, and a predicted actual or likely future leakage event as a red circle. In some examples, a user of user device 114 may control the characteristics of the visual indicators used by the heat map 300. Also, although the example heat map 300 represents the positioners 302-318, in other examples, the heat map 300 can correlate the leakage state with the control valves associated with the positioners 302-318 and display the visual indicators in connection with the control valves instead of the positioners.

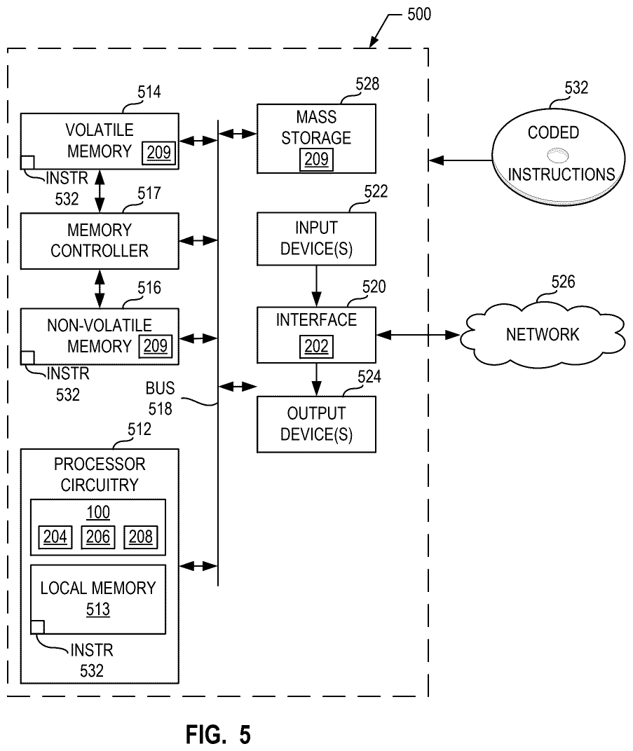

A flowchart representative of example machine readable instructions, which may be executed by programmable circuitry to implement and/or instantiate the leakage detection circuitry 100 of FIG. 2 and/or representative of example operations which may be performed by programmable circuitry to implement and/or instantiate the leakage detection circuitry 100 of FIG. 2, is shown in FIG. 4. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 4, many other methods of implementing the example leakage detection circuitry 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to identify pneumatic leaks associated with a positioner (e.g., the positioner 106 of FIG. 1) for a control valve (e.g., the control valve 102 of FIG. 1). The example machine-readable instructions and/or the example operations 400 of FIG. 4 begin at block 402, at which the relay position data processing circuitry 204 determines whether the relay position data points 220 (e.g., received via the interface circuitry 202) include data point(s) associated with travel feedback data 222 indicative of the control valve 102 being fully closed or fully open (e.g., where the association can be determined based on time-stamps). If the relay position data points 220 do not include data point(s) associated with such travel feedback data 222 (e.g., block 402 returns a result of NO), the relay position data processing circuitry proceeds to block 406. If the relay position data points 220 include data point(s) associated with such travel feedback data 222 (e.g., block 402 returns a result of YES), the relay position data processing circuitry proceeds to block 404.

At block 404, the relay position data processing circuitry 204 removes data point(s) associated with travel feedback data 222 indicative of the valve being fully closed or fully open from the relay position data points 220 (e.g., to remove data point(s) that may skew the leakage detection analysis by falsely implying an increased change in relay position in a direction associated with increase output pressure to compensate for a leak). After removing those data point(s), the relay position data processing circuitry 204 defines an array of (remaining) relay position data points 220 representing relay beam position during modulation of the control valve 102. (Block 406). In the example operations 400 of FIG. 4, the relay position data processing circuitry 204 calculates rolling mean values representing average relay beam position over time using the relay position data points 220 in the relay position array (e.g., a rolling window of the relay position data points 220 in the array) to generate a rolling mean array. (Block 408).

At block 410, the leakage analysis circuitry 206 determines whether the number of rolling mean values in the rolling mean array satisfy a threshold (e.g., defined by the relay position data processing circuitry 204). If the leakage analysis circuitry 206 determines the threshold is not satisfied (e.g., block 410 returns a result of NO), control proceeds to block 422, at which the relay position data processing circuitry 204 determines whether additional relay position data points 220 have been received to enable the relay position data processing circuitry 204 to continue to calculate the rolling mean values until the threshold is satisfied. If the leakage analysis circuitry 206 determines the threshold is met (e.g., block 410 returns a result of YES), control proceeds to block 412.

At block 412, the leakage analysis circuitry 206 identifies the most recently calculated rolling mean value from the rolling mean array. At block 414, the leakage analysis circuitry 206 performs a comparison of the most recent rolling mean value and leakage state threshold value(s) defined by the leakage threshold rule(s) 212. At block 416, the leakage analysis circuitry 206 determines or predicts the positioner leakage state based on the comparison. For example, the leakage analysis circuitry 206 may determine the leakage state of the positioner 106 to be no or likely no leakage event if the most recently calculated rolling mean value falls between two threshold value(s) defining an expected relay beam position. Alternatively, the leakage analysis circuitry 206 may determine the leakage state to be indicative of a leak that is occurring or likely occurring when the most recently calculated rolling mean value is above a threshold value.

In some examples, at block 416 the leakage analysis circuitry 206 predicts a likelihood of a leakage event based on trends with respect to the rolling mean value(s) selected for analysis over time relative to the threshold value(s). For instance, the leakage analysis circuitry 206 can predict that a subsequent rolling mean value for relay position is likely to satisfy the threshold rule indicative of leakage event is likely if previously generated rolling mean value(s) are approaching the threshold value associated with a leakage event.

At block 418, the alert control circuitry 208 determines indicator(s)/alert(s) identifying the positioner leakage state determined by the leakage analysis circuitry at block 418. At block 420, the alert control circuitry 208 outputs the indicator(s)/alert(s) identifying the positioner leakage state. In some examples, the alert control circuitry 208 generates and outputs a heat map representing the determined leakage states of a plurality of positioners at a particular time. For example, the alert control circuitry 208 can generate the example heat map 300 of FIG. 3 to show the leakage states of positioners 302-318 in an environment. In some examples, the alert control circuitry 208 can cause the indicator(s)/alert(s) to be displayed on the display screen 134 of the example user device 114 of FIG. 1.

At block 422, the relay position data processing circuitry 204 determines whether additional relay position data points 220 have been received (e.g., via the interface circuitry 202). If additional relay position data points 220 are received (e.g., block 422 returns a result of YES), control returns to block 402 for, for instance, filtering of the newly received relay position data points 220. If additional relay position data points 220 are not received (e.g., block 422 returns a result of NO), the example operations 400 of FIG. 4 end.

FIG. 5 is a block diagram of an example programmable circuitry platform 500 structured to execute and/or instantiate the example machine-readable instructions and/or the example operations of FIG. 4 to implement the leakage detection circuitry 100 of FIG. 2. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, DSPs, and/or microcontrollers from any desired family or manufacturer. The programmable circuitry 512 may be implemented by one or more semiconductor based (e.g., silicon based) devices. In this example, the programmable circuitry 512 implements the example leakage detection circuitry 100, the example relay position data processing circuitry 204, the example leakage analysis circuitry 206, and the example alert control circuitry 208.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520 (e.g., the interface circuitry 202 of FIG. 2). The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIG. 4, may be stored in the mass storage device 528, in the volatile memory 514, in the non-volatile memory 516, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide for dynamic detection of leaks associated with a positioner of a control valve using relay beam position data as a proxy or indicator for detecting the leaks. Example systems, apparatus, articles of manufacture, and methods disclosed herein enable improved leakage detection in environments containing multiple control valves by performing leakage detection analysis and monitoring during the course of operation of the control valve(s), without taking the control valves offline, and without relying on user involvement to initiate the testing. Example systems, apparatus, articles of manufacture, and methods disclosed herein allow for improved control valve management by providing for tiered identification of leakage states of a positioner, including potential leakage events that warrant monitoring and likely leakage events that warrant action. Example systems, apparatus, articles of manufacture, and methods disclosed herein provide for increased reliability in leakage detection by determining leakage states of positioners based on one variable, namely, a rolling mean of the relay beam position data over time. Thus, examples disclosed herein can detect current leakage states based on relay position data and predict future leakage states based on changes in relay position data over time.

Example apparatus, systems, and method to identify pneumatic leaks are disclosed herein. Further examples and combinations thereof include the following:

Example 1 includes an apparatus comprising interface circuitry, machine-readable instructions, and at least one processor circuit to be programmed by the machine-readable instructions to generate an array including mean relay position values for a relay beam of a positioner associated with a control valve, the array including a first mean relay position value of the mean relay position values, perform a comparison of the first mean relay position value to a threshold rule, and cause an indicator representative of a leakage state of the positioner to be output for presentation at a user device based on the comparison.

Example 2 includes the example of claim 1, wherein one or more of the at least one processor circuit is to cause a first indicator to be output when a difference between the first mean relay position value and the threshold rule is a first amount, and cause a second indicator to be output when the difference between the first mean relay position value and the threshold rule is a second amount different than the first amount.

Example 3 includes the apparatus of examples 1 or 2, wherein the threshold rule is a first threshold rule and one or more of the at least one processor circuit is to perform a comparison of the first mean relay position value to a second threshold rule, the second threshold rule different than the first threshold rule, cause a first indicator to be output when the first mean relay position value fails to satisfy the first threshold rule and the second threshold rule, cause a second indicator to be output when the first mean relay position value satisfies the first threshold rule but not the second threshold rule, and cause a third indicator to be output when the first mean relay position value satisfies the second threshold rule.

Example 4 includes the apparatus of any of examples 1-3, wherein one or more of the at least one processor circuit is to generate a heat map for presentation at the user device, the heat map including the indicator.

Example 5 includes the apparatus of any of examples 1-4, wherein one or more of the at least one processor circuit is to update the array to include a second mean relay position value, the first mean relay position value associated with a first time, the second mean relay position value associated with a second time after the first time, perform a second comparison of the second mean relay position value to the threshold rule, and cause a second indicator representative of a second leakage state of the positioner to be output for presentation at the user device based on the second comparison.

Example 6 includes the apparatus of any of examples 1-5, wherein one or more of the at least one processor circuit is to calculate the first mean relay position value as a rolling mean based on a first data point indicative of a position of the relay beam at a first time and a second data point indicative of a position of the relay beam at a second time.

Example 7 includes the apparatus of any of examples 1-6, wherein one or more of the at least one processor circuit is to filter an array of relay position data points including the first data point and the second data point based on corresponding travel feedback data for an actuator operatively coupled to the positioner to generate a filtered array of relay position data points, and calculate the mean relay position values based on the filtered array of relay position data points.

Example 8 includes the apparatus of any of examples 1-7, wherein the travel feedback data is indicative of the control valve being in a fully closed position or a fully open position.

Example 9 includes an apparatus comprising interface circuitry, machine-readable instructions, and at least one processor circuit to be programmed by the machine-readable instructions to calculate a first mean relay beam position value for a relay beam of a relay of a positioner, the positioner operatively coupled to a control valve, calculate a second mean relay beam position value for the relay beam, perform a comparison of the first mean relay beam position value and the second mean relay beam position value to a threshold, predict a likelihood that a third mean relay beam position value for the relay beam will satisfy the threshold based on the comparison, and cause an alert indicative of a predicted leakage state of the positioner to be output based on the prediction.

Example 10 includes the apparatus of example 9, wherein the alert is a first alert and wherein one or more of the at least one processor circuit is to perform a second comparison of the second mean relay beam position value to the threshold and cause a second alert indicative of a determined leakage state of the positioner to be output based on the second comparison, the second alert output before the first alert.

Example 11 includes the apparatus of examples 9 or 10, wherein the alert includes a first visual representation to be displayed at a user device.

Example 12 includes the apparatus of any of examples 9-11, wherein the at least one processor circuit is to calculate the first mean relay beam position value based on a first subset of relay beam position data points associated with a first time interval and the second mean relay beam position value based on a second subset of relay beam position data points associated with a second time interval.

Example 13 includes the apparatus of any of examples 9-12, wherein the at least one processor circuit is to filter relay beam position data points to remove relay beam position data points indicative of the control valve in a fully closed position or a fully open position, the first subset and the second subset including the relay beam position data points remaining after the filtering.

Example 14 includes the apparatus of any of examples 9-13, wherein the alert is a first alert, and the at least one processor circuit is to generate a heat map including the first alert and a second alert indicative of a leakage state for a second positioner.

Example 15 includes at least one non-transitory machine-readable medium comprising machine-readable instructions to cause at least one processor circuit to at least generate a first array of mean relay position values for a relay of a first positioner associated with a first control valve, determine that a first mean relay position value of the first array corresponds to a first leakage state of the first positioner based on a first comparison of the first mean relay position value to a threshold value, and cause a first indicator of the first leakage state of the first positioner to be output.

Example 16 includes the apparatus of example 15, wherein the machine-readable instructions are to cause one or more of the at least one processor circuit to generate a second array of mean relay position values for a second relay of a second positioner associated with a second control valve, determine that a second mean relay position value of the second array of mean relay position values corresponds to a second leakage state of the second positioner based on a second comparison of the second mean relay position value to the threshold value, and cause a heat map including the first indicator and a second indicator of the second leakage state of the second positioner to be output.

Example 17 includes the apparatus of examples 15 or 16, wherein the machine-readable instructions are to cause one or more of the at least one processor circuit to detect, based on a second mean relay position value of the first array of mean relay position values for the first positioner, a change in a leakage state of the first positioner from the first leakage state to a second leakage state, the first mean relay position value associated with a first time interval and the second mean relay position value associated with a second time interval after the first time interval, and change the first indicator to a second indicator based on the detection.

Example 18 includes the apparatus of any of examples 15-17, wherein the machine-readable instructions are to cause one or more of the at least one processor circuit to calculate rolling mean values of relay position data points generated for the relay of the first positioner over time, the mean relay position values of the first array corresponding to the rolling mean values.

Example 19 includes the apparatus of any of examples 15-18, wherein the machine-readable instructions are to cause one or more of the at least one processor circuit to filter an array of the relay position data points based on travel feedback data indicative of a position of the first control valve to generate a filtered array of relay position data points, and calculate the rolling mean values based on the filtered array of relay position data points.

Example 20 includes the apparatus of any of examples 15-19, wherein the first indicator includes a visual representation to be displayed at a user device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
generate an array including mean relay position values for a relay beam of a positioner associated with a control valve, the array including a first mean relay position value of the mean relay position values;
perform a comparison of the first mean relay position value to a threshold rule; and
cause an indicator representative of a leakage state of the positioner to be output for presentation at a user device based on the comparison.

2. The apparatus of claim 1, wherein one or more of the at least one processor circuit is to:
cause a first indicator to be output when a difference between the first mean relay position value and the threshold rule is a first amount; and
cause a second indicator to be output when the difference between the first mean relay position value and the threshold rule is a second amount different than the first amount.

3. The apparatus of claim 1, wherein the threshold rule is a first threshold rule and one or more of the at least one processor circuit is to:
perform a comparison of the first mean relay position value to a second threshold rule, the second threshold rule different than the first threshold rule;
cause a first indicator to be output when the first mean relay position value fails to satisfy the first threshold rule and the second threshold rule;
cause a second indicator to be output when the first mean relay position value satisfies the first threshold rule but not the second threshold rule; and
cause a third indicator to be output when the first mean relay position value satisfies the second threshold rule.

4. The apparatus of claim 1, wherein one or more of the at least one processor circuit is to generate a heat map for presentation at the user device, the heat map including the indicator.

5. The apparatus of claim 1, wherein one or more of the at least one processor circuit is to:
update the array to include a second mean relay position value, the first mean relay position value associated with a first time, the second mean relay position value associated with a second time after the first time;
perform a second comparison of the second mean relay position value to the threshold rule; and
cause a second indicator representative of a second leakage state of the positioner to be output for presentation at the user device based on the second comparison.

6. The apparatus of claim 1, wherein one or more of the at least one processor circuit is to calculate the first mean relay position value as a rolling mean based on a first data point indicative of a position of the relay beam at a first time and a second data point indicative of a position of the relay beam at a second time.

7. The apparatus of claim 6, wherein one or more of the at least one processor circuit is to:
filter an array of relay position data points including the first data point and the second data point based on corresponding travel feedback data for an actuator operatively coupled to the positioner to generate a filtered array of relay position data points; and
calculate the mean relay position values based on the filtered array of relay position data points.

8. The apparatus of claim 7, wherein the travel feedback data is indicative of the control valve being in a fully closed position or a fully open position.

9. An apparatus comprising:
interface circuitry;
machine-readable instructions; and
at least one processor circuit to be programmed by the machine-readable instructions to:
calculate a first mean relay beam position value for a relay beam of a relay of a positioner, the positioner operatively coupled to a control valve;
calculate a second mean relay beam position value for the relay beam;
perform a comparison of the first mean relay beam position value and the second mean relay beam position value to a threshold;
predict a likelihood that a third mean relay beam position value for the relay beam will satisfy the threshold based on the comparison; and
cause an alert indicative of a predicted leakage state of the positioner to be output based on the prediction.

10. The apparatus of claim 9, wherein the alert is a first alert and wherein one or more of the at least one processor circuit is to:
perform a second comparison of the second mean relay beam position value to the threshold; and
cause a second alert indicative of a determined leakage state of the positioner to be output based on the second comparison, the second alert output before the first alert.

11. The apparatus of claim 9, wherein the alert includes a first visual representation to be displayed at a user device.

12. The apparatus of claim 9, wherein the at least one processor circuit is to calculate the first mean relay beam position value based on a first subset of relay beam position data points associated with a first time interval and the second mean relay beam position value based on a second subset of relay beam position data points associated with a second time interval.

13. The apparatus of claim 12, wherein the at least one processor circuit is to filter relay beam position data points to remove relay beam position data points indicative of the control valve in a fully closed position or a fully open position, the first subset and the second subset including the relay beam position data points remaining after the filtering.

14. The apparatus of claim 12, wherein the alert is a first alert, and the at least one processor circuit is to generate a heat map including the first alert and a second alert indicative of a leakage state for a second positioner.

15. At least one non-transitory machine-readable medium comprising machine-readable instructions to cause at least one processor circuit to at least:
generate a first array of mean relay position values for a relay of a first positioner associated with a first control valve;
determine that a first mean relay position value of the first array corresponds to a first leakage state of the first positioner based on a first comparison of the first mean relay position value to a threshold value; and
cause a first indicator of the first leakage state of the first positioner to be output.

16. The at least one non-transitory machine-readable medium of claim 15, wherein the machine-readable instructions are to cause one or more of the at least one processor circuit to:
generate a second array of mean relay position values for a second relay of a second positioner associated with a second control valve;
determine that a second mean relay position value of the second array of mean relay position values corresponds to a second leakage state of the second positioner based on a second comparison of the second mean relay position value to the threshold value; and
cause a heat map including the first indicator and a second indicator of the second leakage state of the second positioner to be output.

17. The at least one non-transitory machine-readable medium of claim 15, wherein the machine-readable instructions are to cause one or more of the at least one processor circuit to:
detect, based on a second mean relay position value of the first array of mean relay position values for the first positioner, a change in a leakage state of the first positioner from the first leakage state to a second leakage state, the first mean relay position value associated with a first time interval and the second mean relay position value associated with a second time interval after the first time interval; and
change the first indicator to a second indicator based on the detection.

18. The at least one non-transitory machine-readable medium of claim 15, wherein the machine-readable instructions are to cause one or more of the at least one processor circuit to calculate rolling mean values of relay position data points generated for the relay of the first positioner over time, the mean relay position values of the first array corresponding to the rolling mean values.

19. The at least one non-transitory machine-readable medium of claim 18, wherein the machine-readable instructions are to cause one or more of the at least one processor circuit to:
filter an array of the relay position data points based on travel feedback data indicative of a position of the first control valve to generate a filtered array of relay position data points; and
calculate the rolling mean values based on the filtered array of relay position data points.

20. The at least one non-transitory machine-readable medium of claim 15, wherein the first indicator includes a visual representation to be displayed at a user device.
